(19) United States
(12) Patent Application Publication
(10) Pub. No.: US 2024/0020871 A1
(43) Pub. Date: Jan. 18, 2024

(54) OBJECT RECOGNITION DEVICE AND OBJECT PROCESSING APPARATUS

(71) Applicant: PFU LIMITED, Ishikawa (JP)

(72) Inventors: Masanobu HONGO, Ishikawa (JP); Jian LI, Ishikawa (JP)

(21) Appl. No.: 18/359,524

(22) Filed: Jul. 26, 2023

Related U.S. Application Data
(63) Continuation of application No. PCT/JP2021/028844, filed on Aug. 3, 2021.

(30) Foreign Application Priority Data
Feb. 3, 2021 (JP) 2021-015927

(51) Int. Cl. G06T 7/70; G06V 10/141; G06V 10/143

(52) U.S. Cl. CPC G06T 7/70; G06V 10/141; G06V 10/143; G06V 2201/07; G06T 2207/10144; G06T 2207/20132

(57) ABSTRACT

An object recognition device includes an illuminator configured to illuminate an object, an imager configured to take a first-type image of the object when the object is illuminated by the illuminator under a first illumination condition, and take a second-type image of the object when the object is illuminated by the illuminator under a second illumination condition different than the first illumination condition, and circuitry configured to calculate a position of the object based on the first-type image and the second-type image.

### CROSS-REFERENCE TO RELATED APPLICATION

This application is a continuation of PCT International Application No. PCT/JP2021/028844 filed on Aug. 3, 2021 which claims the benefit of priority from Japanese Patent Application No. 2021-015927 filed on Feb. 3, 2021, the entire contents of which are incorporated herein by reference.

### FIELD

The embodiment discussed herein is related to an object recognition device and an object processing apparatus.

### BACKGROUND

A recyclable waste auto-segregation device is known that segregates recyclable waste, which is represented by glass bottles and plastic bottles, according to the material. A recyclable waste auto-segregation device includes an image processing device that determines the quality of material and the position of the recyclable waste based on the images in which the recyclable waste is captured; and includes a robot that moves the recyclable waste of a predetermined material to a predetermined position.

In a picture in which recyclable waste appears, if the recyclable waste is made of a light transmissive material, then sometimes the background behind the recyclable waste also appears due to the light passing through the recyclable waste. Moreover, in a picture in which recyclable waste appears, if the recyclable waster is glossy in nature, then there are times when the light that undergoes specular reflection from the recyclable waste causes overexposure. In an object recognition device, if such a distracting picture appears in the picture in which the recyclable waste is captured, then the picture of the recyclable waste cannot be appropriately extracted from the image, and the position of the recyclable waste may not be appropriately calculated. If the position of the recyclable waste is not appropriately calculated, then a recyclable waste auto-segregation device cannot appropriately segregate the recyclable waste.

### SUMMARY

According to an aspect of an embodiment, an object recognition device includes an illuminator configured to illuminate an object, an imager configured to take a first-type image of the object when the object is illuminated by the illuminator under a first illumination condition, and take a second-type image of the object when the object is illuminated by the illuminator under a second illumination condition different than the first illumination condition, and circuitry configured to calculate a position of the object based on the first-type image and the second-type image. According to an aspect of an embodiment, an object processing apparatus includes a remover configured to remove an object, a driver configured to move the remover, an illuminator configured to illuminate the object, an imager configured to take a first-type image of the object when the object is illuminated by the illuminator under a first illumination condition, and take a second-type image of the object when the object is illuminated by the illuminator under a second illumination condition different than the first illumination condition, and circuitry configured to calculate a position of the object based on the first-type image and the second-type image, and control the driver based on the position such that the remover removes the object.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a perspective view of a recyclable waste auto-segregation device in which an object processing apparatus is installed, according to an embodiment of the present disclosure;

FIG. 2 is a cross-sectional view of an opto-electronic unit, according to an embodiment of the present disclosure;

FIG. 3 is a block diagram illustrating a control device, according to an embodiment of the present disclosure;

FIG. 4 is a flowchart for describing the operation performed by the control device for controlling a robot unit and the opto-electronic unit, according to an embodiment of the present disclosure;

FIG. 5 is a diagram illustrating a high-light-intensity partial image, according to an embodiment of the present disclosure; and

FIG. 6 is a diagram illustrating a low-light-intensity partial image, according to an embodiment of the present disclosure.

### DESCRIPTION OF EMBODIMENTS

Preferred embodiments of the disclosure will be described with reference to accompanying drawings. An exemplary embodiment of an object recognition device and an object processing apparatus according to the application concerned is described below with reference to the drawings. However, the technology disclosed herein is not limited by the description given below. Moreover, in the following description, identical constituent elements are referred to by the same reference numerals, and their description is not given repeatedly.

### Embodiment

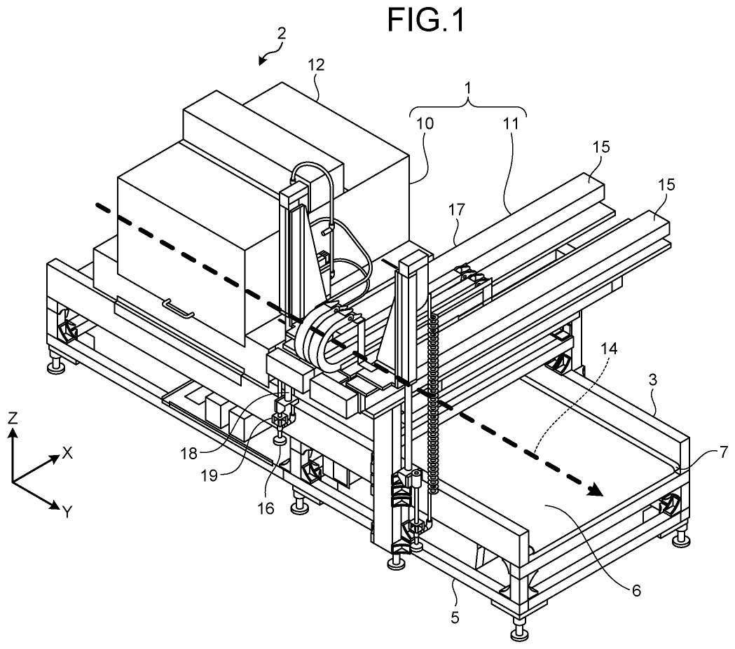

As illustrated in FIG. 1, an object processing apparatus 1 according to the embodiment is installed in a recyclable waste auto-segregation device 2. FIG. 1 is a perspective view of the recyclable waste auto-segregation device 2 in which the object processing apparatus 1 according to the embodiment is installed. The recyclable waste auto-segregation device 2 includes the object processing apparatus 1 and a carrier device 3. The carrier device 3 is made of, what is called, a belt conveyer that includes a belt conveyer frame 5, a belt 6, and a plurality of fixed pulleys 7; and also includes a belt driving device (not illustrated). The belt conveyer frame 5 is mounted on the same mounting surface on which the recyclable waste auto-segregation device 2 is installed. The belt 6 is made of a flexible material and is formed in a looped shape.

The fixed pulleys 7 are formed in a columnar shape, and are placed along the directions of a plurality of rotation axes. Each rotation axis is parallel to the X-axis, which is parallel to the plane along which the mounting surface is formed; and overlaps with one of the other planes parallel to the plane along which the mounting surface is formed. The fixed pulleys 7 are supported by the belt conveyer frame 5 in a rotatable manner around the corresponding rotation axes. The belt 6 is wound around the fixed pulleys 7, and is movably supported by the belt conveyer frame 5. The belt 6 has an upper portion positioned on the upper side of the fixed pulleys 7, and has a lower portion positioned on the lower side of the fixed pulleys 7. The upper portion runs along the other planes parallel to the plane along which the mounting surface is formed. The belt driving device rotates the fixed pulleys 7 in such a way that the upper portion of the belt 6 moves parallel to the Y-axis. The Y-axis is parallel to the plane along which the mounting surface is formed, and is perpendicular to the X-axis.

The object processing apparatus 1 includes an object recognition device 10 and a robot unit 11 according to the embodiment. The object recognition device 10 includes an opto-electronic unit 12 that is placed above some part of the upper portion of the belt 6. The robot unit 11 is placed on the upper side of some other part of the upper portion of the belt 6, and is placed more on the downstream side of a carrier direction 14 as compared to the object recognition device 10. The carrier direction 14 is parallel to the Y-axis.

The robot unit 11 includes a plurality of picking robots 15 and includes a suction pump (not illustrated). A picking robot of the plurality of picking robots 15 includes a suction pad 16, an X-axis actuator 17, a Z-axis actuator 18, and a holding sensor 19; as well as includes a dumping case (not illustrated) and a solenoid valve (not illustrated). The dumping case is placed beside the carrier device 3 on the mounting surface. The suction pad 16 is supported by the belt conveyer frame 5 via the X-axis actuator 17 and the Z-axis actuator 18 to be translatable parallel to the X-axis or the Z-axis. The Z-axis is perpendicular to the plane along which the mounting surface is formed, that is, is perpendicular to the X-axis and the Y-axis. The motion range of the suction pad 16 includes an initial position. When placed at the initial position, the suction pad 16 is present on the upper side of the dumping case. Of the suction pad 16, the undersurface opposite to the mounting surface has an air inlet formed thereon. The suction pump is connected to the suction pad 16 via a pipe (not illustrated), and sucks the air through the air inlet of the suction pad 16. The solenoid valve is placed midway through the pipe that connects the suction pad 16 and the suction pump. When opened, the solenoid valve connects the suction pad 16 to the suction pump in such a way that the air gets sucked through the air inlet of the suction pad 16. On the other hand, when closed, the solenoid valve shuts the connection between the suction pad 16 and the suction pump so that the air is not sucked through the air inlet of the suction pad 16.

The X-axis actuator 17 moves the suction pad 16 in the direction parallel to the X-axis. The Z-axis actuator 18 moves the suction pad 16 in the direction parallel to the Z-axis. The holding sensor 19 detects whether or not an object is held by the suction pad 16. Another picking robot from among a plurality of picking robots 15 is formed in an identical manner to the picking robot. That is, another picking robot also includes a suction pad, an X-axis actuator, a Z-axis actuator, a holding sensor, a dumping case, and a solenoid valve.

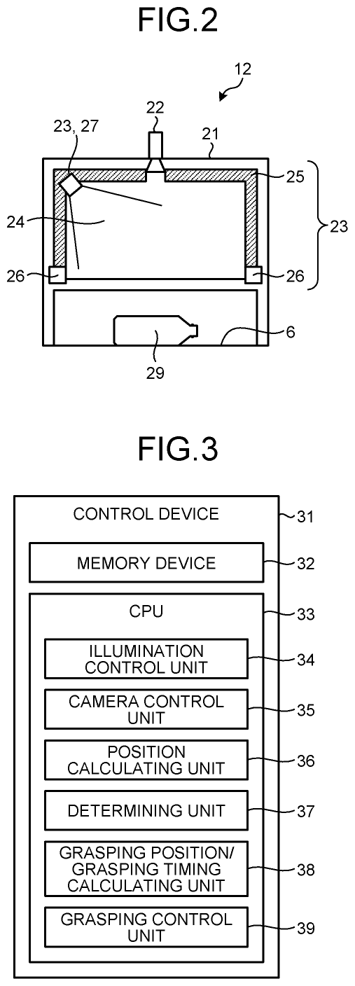

FIG. 2 is a cross-sectional view of the opto-electronic unit 12. The opto-electronic unit 12 includes a housing 21, a camera 22, and an illumination device 23. The housing 21 is made of non-transmissive material and has a box shape. The housing 21 has an internal space 24 formed therein. The housing 21 is placed on the upper side of the belt 6 in such a way that some part of the upper portion of the belt 6 is present within the internal space 24 of the housing 21. Moreover, the housing 21 is fixed to the belt conveyer frame 5 of the carrier device 3. The housing 21 shields the outside light and prevents it from entering the internal space 24 of the housing 21. The housing 21 has an inlet and an outlet formed thereon. The inlet is formed in the upstream portion of the housing 21 in the carrier direction 14, and the internal space 24 is linked to the outside of the housing 21 via the inlet. The outlet is formed in the downstream portion of the housing 21 in the carrier direction 14, and the internal space 24 is linked to the outside of the housing 21 via the outlet.

The camera 22 is placed on the upper side of the housing 21. The camera 22 is fixed to the housing 21, that is, is fixed to the belt conveyer frame 5 via the housing 21. The camera 22 is, what is called, a digital camera that uses the visible light and takes an image for capturing a photographic subject 29 placed in that part of the upper portion of the belt 6 which is present within the internal space 24. An image has a plurality of pixels paved therein. The pixels are associated to a plurality of sets of color information. Each set of color information indicates, for example, a red gradation value, a green gradation value, and a blue gradation value. Meanwhile, an image can also be a black-and-white image. In that case, the color information indicates a single gradation value.

The illumination device 23 includes a reflecting member 25, a plurality of light sources 26, and an ultraviolet light source 27. The reflecting member 25 covers roughly the entire internal surface of the housing 21 that faces the internal space 24; and is placed to enclose the camera 22, that is, is placed to enclose the point of view of the image taken by the camera 22. The reflecting member 25 causes diffused reflection of the light falling thereon. The light sources 26 are placed on the inside of the housing 21 and on the lower side close to the belt 6. The light sources 26 emit a visible light having a low light intensity or emit a visible light having a high light intensity onto the reflecting member 25. The ultraviolet light source 27 is placed on the inside of the housing 21 and on the upper side at a distance from the belt 6. The ultraviolet light source 27 emits an ultraviolet light toward the upper portion of the belt 6.

The object recognition device 10 further includes a control device 31 as illustrated in FIG. 3. FIG. 3 is a block diagram illustrating the control device 31. The control device 31 is a computer that includes a memory device 32 and a central processing unit (CPU) 33. The memory device 32 is used to record a computer program to be installed in the control device 31, and to record the information to be used by the CPU 33. Examples of the memory device 32 include a memory such as a random access memory (RAM) or a read only memory (ROM); a fixed disk device such as a hard disk; and a solid state drive (SSD).

The CPU 33 executes the computer program installed in the control device 31 and accordingly performs information processing; controls the memory device 32; and controls the camera 22, the light sources 26, the X-axis actuator 17, the Z-axis actuator 18, the holding sensor 19, and the solenoid valve. The computer program installed in the control device 31 includes a plurality of computer programs meant for implementing a plurality of functions of the control device 31. Those functions include an illumination control unit 34, a camera control unit 35, a position calculating unit 36, a determining unit 37, a holding position/holding timing calculating unit 38, and a holding control unit 39.

The illumination control unit 34 controls the illumination device 23 in such a way that the photographic subject 29 placed in the internal space 24 gets illuminated under a plurality of illumination conditions. That is, the illumination control unit 34 controls the light sources 26 in such a way that the light sources 26 switch on at a low light intensity or at a high light intensity, or in such a way that the light sources 26 switch off. Moreover, the illumination control unit 34 controls the ultraviolet light source 27 to ensure switching on and switching off of the ultraviolet light source 27. The camera control unit 35 controls the camera 22 to use the visible light and take an image that captures the photographic subject present within the internal space 24 of the housing 21. Moreover, the camera control unit 35 controls the memory device 32 in such a way that the data of the image taken by the camera 22 is recorded in the memory device 32 in a corresponding manner to the image capturing timing.

The position calculating unit 36 performs image processing with respect to the image taken by the camera control unit 35, and clips partial images from that image. Then, the position calculating unit 36 performs image processing with respect to a plurality of clipped partial images, and determines whether or not objects appear in the partial images. If it is determined that an object appears in a partial image, then the position calculating unit 36 performs further image processing with respect to that partial image and calculates the position of placement of the center of gravity of the object. Moreover, when it is determined that an object appears in a partial image, the position calculating unit 36 performs further image processing with respect to the partial image so as to determine the material of the object and, based on the determined material, determines whether or not the object is a holding target.

When it is determined that a holding target appears in a partial image, the holding position/holding timing calculating unit 38 calculates the holding position and the holding timing based on: the image capturing timing at which the image was taken by the camera control unit 35; the position calculated by the position calculating unit 36; and the carrier speed. The holding control unit 39 controls the X-axis actuator 17 in such a way that the suction pad 16 gets placed at a holding preparation position, which is on the upper side of the holding position that is calculated by the holding position/holding timing calculating unit 38, before the arrival of the holding timing, which is also calculated by the holding position/holding timing calculating unit 38. Moreover, the holding control unit 39 controls the Z-axis actuator 18 in such a way that the suction pad 16 gets placed on the upper side of the holding position, which is calculated by the holding position/holding timing calculating unit 38, at the holding timing, which is also calculated by the holding position/holding timing calculating unit 38. Furthermore, the holding control unit 39 controls the solenoid valve in such a way that the air is sucked through the opening of the suction pad 16 at the holding timing calculated by the holding position/holding timing calculating unit 38.

The operations performed in the recyclable waste auto-segregation device 2 include an operation for carrying the recyclable waste as performed by the carrier device 3, and an operation for controlling the robot unit 11 and the opto-electronic unit 12 as performed by the control device 31. In the operation for carrying the recyclable waste as performed by the carrier device 3, firstly, the user operates the carrier device 3 and activates it. As a result of the activation of the carrier device 3, the belt driving device of the carrier device 3 rotates the fixed pulleys 7 at a predetermined rotation speed. When the fixed pulleys 7 rotate at a predetermined rotation speed, the upper portion of the belt 6 performs translation in the carrier direction at a predetermined carrier speed. Moreover, in the upper portion of the belt 6, the user places a plurality of pieces of recyclable waste on the upstream side in the carrier direction 14 of the opto-electronic unit 12. Examples of the recyclable waste include plastic bottles and glass bottles. When the upper portion of the belt 6 performs translation in the carrier direction 14 at the carrier speed, the pieces of recyclable waste placed in the upper portion of the belt 6 are carried in the carrier direction 14 at the carrier speed. Due to the translation occurring in the carrier direction 14, the pieces of recyclable waste enter the internal space 24 of the housing 21 via the inlet, and move out of the internal space 24 of the housing 21 via the outlet.

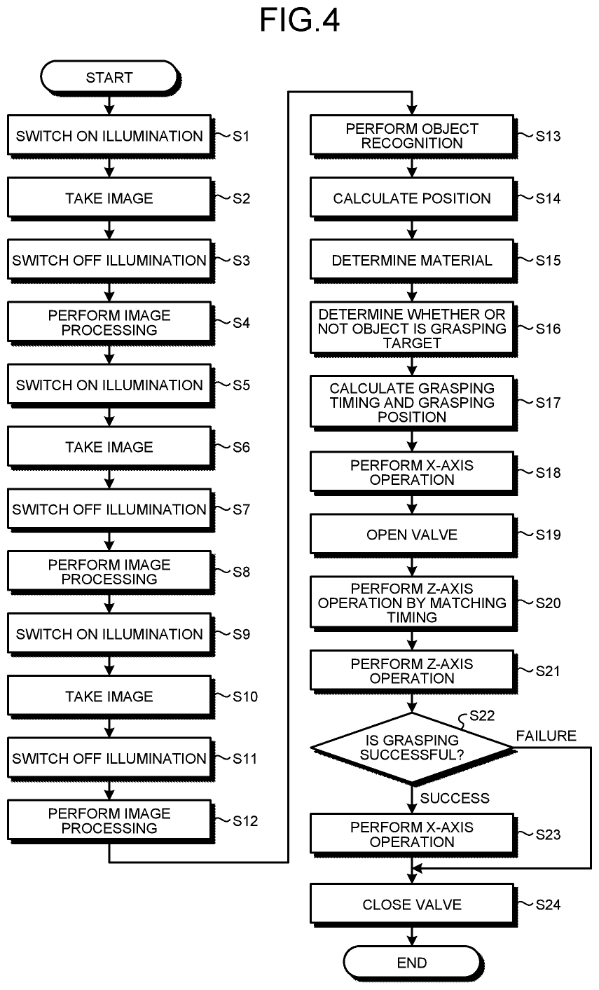

FIG. 4 is a flowchart for describing the operation performed by the control device 31 for controlling the robot unit 11 and the opto-electronic unit 12. The operation for controlling the robot unit 11 and the opto-electronic unit 12 as performed by the control device 31 is carried out in tandem with the operation for carrying the recyclable waste as performed by the carrier device 3. The control device 31 controls the light sources 26 to switch them on and to make them emit a visible light having a high light intensity (Step S1). The visible light having a high light intensity and emitted from the light sources 26 undergoes diffused reflection from the surface of the reflecting member 25 and falls on the pieces of recyclable waste carried by the carrier device 3. That is, the illumination device 23 illuminates a plurality of pieces of recyclable waste using the visible light that has a high light intensity and that is emitted from the surface light source enclosing the camera 22.

When a plurality of pieces of recyclable waste is illuminated by the illumination device 23 using the visible light having a high light intensity, the control device 31 controls the camera 22 to use the visible light and take a high-light-intensity image in which the pieces of recyclable waste are captured (Step S2). After the high-light-intensity image is taken in which the pieces of recyclable waste are captured, the control device 31 controls the light sources 26 and switches them off (Step S3). Moreover, the control device 31 records, in the memory device 32, the high-light-intensity image in a corresponding manner to the image capturing timing. Then, the control device 31 performs image processing with respect to the recorded high-light-intensity image and clips, from the high-light-intensity image, a high-light-intensity partial image appearing in a predetermined region of the high-light-intensity image (Step S4).

After the light sources 26 are switched off, the control device 31 controls the ultraviolet light source 27, switches it on, and makes it emit an ultraviolet light (Step S5). The ultraviolet light emitted from the ultraviolet light source 27 is projected onto the pieces of recyclable waste that are carried by the carrier device 3. That is, the illumination device 23 projects an ultraviolet light onto the pieces of recyclable waste that have entered the internal space 24, and illuminates those pieces with the ultraviolet light.

While the pieces of recyclable waste are illuminated by the illumination device 23, the control device 31 controls the camera 22 to use the visible light and take a fluorescence image in which the pieces of recyclable waste are captured (Step S6). The timing at which the fluorescence image is taken is identical to a timing arriving after a predetermined first-type elapsed time (for example, a few tens of milliseconds) since the timing at which the high-light-intensity image was taken. After the fluorescence image is taken, the control device 31 controls the ultraviolet light source 27 and switches it off (Step S7). Moreover, the control device 31 records, in the memory device 32, the fluorescence image in a corresponding manner to the image capturing timing.

Then, the control device 31 performs image processing with respect to the fluorescence image and clips, from the fluorescence image, a fluorescence partial image appearing in that region of the fluorescence image which is calculated based on the first-type elapsed time (Step S8). Meanwhile, because of the ongoing translation of the upper portion of the belt 6, the region of the upper portion of the belt 6 which appears in the fluorescence image is different than the region of the upper portion of the belt 6 which appears in the high-light-intensity image. The fluorescence partial image is extracted from the fluorescence image in such a way that the region of the upper portion of the belt 6 appearing in the fluorescence partial image is identical to the region of the upper portion of the belt 6 appearing in the high-light-intensity image. That is, that region in the fluorescence image in which the fluorescence partial image appears is calculated based on the first-type elapsed time in such a way that the region of the upper portion of the belt 6 appearing in the fluorescence partial image is identical to the region of the upper portion of the belt 6 appearing in the high-light-intensity image.

After the ultraviolet light source 27 is switched off, the control device 31 controls the light sources 26, switches them on, and makes them emit a visible light having a low light intensity (Step S9). The visible light having a low light intensity and emitted from the light sources 26 undergoes diffused reflection from the surface of the reflecting member 25 and falls on the pieces of recyclable waste carried by the carrier device 3. That is, the illumination device 23 illuminates a plurality of pieces of recyclable waste using the visible light that has a low light intensity and that is emitted from the surface light source enclosing the camera 22.

When a plurality of pieces of recyclable waste is illuminated by the illumination device 23 using the visible light having a low light intensity, the control device 31 controls the camera 22 to use the visible light and take a low-light-intensity image in which the pieces of recyclable waste are captured (Step S10). The timing at which the low-light-intensity image is taken is identical to a timing arriving after a predetermined second-type elapsed time (for example, a few tens of milliseconds) since the timing at which the fluorescence image was taken. After the low-light-intensity image is taken, the control device 31 controls the light sources 26 and switches them off (Step S11). Moreover, the control device 31 records, in the memory device 32, the low-level-intensity image in a corresponding manner to the image capturing timing.

Then, the control device 31 performs image processing with respect to the low-light-intensity image and clips, from the low-light-intensity image, a low-light-intensity partial image appearing in that region of the low-light-intensity image which is calculated based on the second-type elapsed time (Step S12). Meanwhile, because of the ongoing translation of the upper portion of the belt 6, the region of the upper portion of the belt 6 which appears in the low-light-intensity image is different than the region of the upper portion of the belt 6 which appears in the high-light-intensity image and is different than that region of the upper portion of the belt 6 which appears in the fluorescence image. The low-light-intensity partial image is extracted from the low-light-intensity image in such a way that the region of the upper portion of the belt 6 appearing in the low-light-intensity partial image is identical not only to the region of the upper portion of the belt 6 appearing in the high-light-intensity image but also to the region of the upper portion of the belt 6 appearing in the fluorescence image. That is, the region in the low-light-intensity image in which the low-light-intensity partial image appears is calculated based on the first-type elapsed time and the second-type elapsed time in such a way that the region appearing in the low-light-intensity partial image is identical to the region appearing in the high-light-intensity image and the fluorescence partial image.

The control device 31 performs image processing with respect to a plurality of partial images including the high-light-intensity image, the low-light-intensity image, and the fluorescence image; and determines whether or not an object appears in the partial images (Step S13). If it is determined that an object appears in the partial images, then the control device 31 performs image processing with respect to the partial images and calculates the position of placement of the center of gravity of that object (Step S14). Moreover, when it is determined that an object appears in the partial images, the control device 31 performs image processing with respect to the partial images and determines the material of that object (Step S15).

Subsequently, based on the material determined at Step S15, the control device 31 determines whether or not the object is a segregation target (Step S16). If it is determined that the object is a segregation target, then the control device 31 determines a picking robot from among a plurality of picking robots 15, to be used for holding the segregation target. When a target picking robot is determined to be used for holding the segregation target, the control device 31 calculates the holding timing and the holding position (Step S17). The holding timing is calculated based on: the image capturing timing at which the image having the holding target appearing therein is taken; the position of placement of the center of gravity of the holding target at the calculated image capturing timing; the carrier speed; and the position in the Y-axis direction of the target picking robot. The holding timing indicates the timing at which the holding target passes through the motion range of the suction pad 16 of the target picking robot. The holding position indicates the position of placement of the center of gravity of the holding target at the holding timing, that is, indicates that position in the motion range of the suction pad 16 of the target picking robot through which the holding target passes.

The control device 31 controls the X-axis actuator 17 of the target picking robot and places the suction pad 16 of the target picking robot at the holding preparation position (Step S18). The holding preparation position is present on the upper side of the holding position; and the X-axis position in the X-axis direction of the holding preparation position is identical to the X-axis position in the X-axis direction of the holding position. That is, the pictorial figure obtained as a result of orthogonal projection of the suction pad 16, which is placed at the holding preparation position, onto the X-axis overlaps with the pictorial figure obtained as a result of orthogonal projection of the holding target, which is placed at the holding position, onto the X-axis. After the suction pad 16 is placed at the holding preparation position, the control device 31 controls the solenoid valve so that the suction pad 16 is connected to the suction pump and the air is sucked through the opening of the suction pad 16 (Step S19).

The control device 31 controls the Z-axis actuator 18 of the target picking robot 15 and places the opening of the suction pad 16 of the target picking robot 15 at the holding position at the holding timing (Step S20). When the opening of the suction pad 16 gets placed at the holding position at the holding timing, the suction pad 16 makes contact with the holding target. When the holding target comes in contact with the opening of the suction pad 16, since the air has already been sucked through the opening of the suction pad 16, the holding target gets held by the suction pad 16. After the suction pad 16 is placed at the holding position, the control device 31 controls the Z-axis actuator 18 and places the suction pad 16 at the holding preparation position (Step S21). As a result of placing the suction pad 16 at the holding preparation position, the holding target gets lifted up from the belt 6.

When the suction pad 16 is placed at the holding preparation position, the control device 31 controls the holding sensor 19 of the target picking robot 15 and determines whether or not the holding target is appropriately held by the suction pad 16 (Step S22). If the holding target is appropriately held by the suction pad 16 (Success at Step S22), then the control device 31 controls the X-axis actuator 17 and places the suction pad 16 at the initial position (Step S23).

After the suction pad 16 is placed at the initial position, the control device 31 controls the solenoid valve and terminates the connection between the suction pad 16 and the suction pump, so that there is no suction of the air through the opening of the suction pad 16 (Step S24). As a result of ensuring that there is no suction of the air through the opening of the suction pad 16, the holding target that is held by the suction pad 16 gets released from the suction pad 16 and falls down into the dumping case of the target picking robot. On the other hand, if the holding target is not appropriately held by the suction pad 16 (Failure at Step S22), then the control device 31 controls the solenoid valve and closes it, so that there is no suction of the air through the opening of the suction pad 16 (Step S24). Meanwhile, if a plurality of holding targets is captured in a taken image, then the control device 31 performs the operations from Step S18 to Step S24 in a repeated manner.

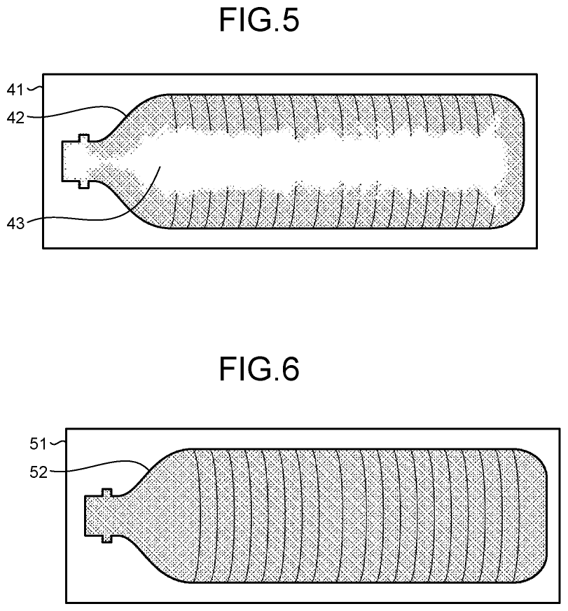

In a high-light-intensity partial image 41 that is clipped from a high-light-intensity image taken when a plurality of pieces of recyclable waste is illuminated by the visible light having a high light intensity; for example, a picture 42 of a photographic subject 29 appears as illustrated in FIG. 5. FIG. 5 is a diagram illustrating the high-light-intensity partial image 41. The picture 42 includes an overexposed region 43 in which overexposure has occurred and which is entirely filled with white color. That is, in each pixel included in the overexposed region 43; the red gradation value, the green gradation value, and the blue gradation value indicate the upper limit value. Such overexposure occurs when the photographic subject 29 has a glossy surface and the light emitted onto the photographic subject 29 from the illumination device 23 undergoes specular reflection from the surface of the photographic subject 29.

When the light emitted from the surface light source of the illumination device 23 falls on the photographic subject 29, the proportion of the dimension of the overexposed region 43 with respect to the dimension of the picture 42 is greater than a predetermined value. That is, the reflecting member 25 of the illumination device 23 is formed in such a way that the proportion of the dimension of the overexposed region 43 with respect to the dimension of the picture 42 becomes greater than a predetermined value. Moreover, the light sources 26 of the illumination device 23 are set in such a way that, at the time of emission of the visible light having a high light intensity, the amount of high-light-intensity visible light emitted from the light sources 26 becomes greater than a predetermined value so as to ensure that the overexposed region 43 is included in the picture 42.

In the picture 42, there are times when distracting images appear that obstruct the extraction of the picture 42 from the high-light-intensity partial image 41. For example, if the photographic subject 29 has a film pasted onto its surface or has an image such as characters, an illustration, or a photograph printed onto its surface, then there are times when that picture appears in the picture 42. Moreover, if the photographic subject 29 is made of a light transmissive material, then the background behind the photographic subject 29 appears in the picture 42 due to the light passing through the photographic subject 29. Examples of the light transmissive material include polyethylene terephthalate (PET) and glass. When a distracting picture appears in the picture 42, the control device 31 may mistakenly extract the picture of the background as the picture 42 capturing the photographic subject 29. If the picture of the photographic subject 29 is incorrectly extracted from the high-light-intensity partial image 41, then sometimes the control device 31 cannot appropriately calculate the position of placement of the center of gravity of the photographic subject 29. In the object processing apparatus 1, when the position of placement of the center of gravity of the photographic subject 29 is not appropriately calculated, there are times when the photographic subject 29 is not appropriately held.

As a result of having a large proportion of the dimension of the overexposed region 43 with respect to the dimension of the picture 42, the control device 31 becomes able to relatively reduce the proportion of the dimension of the distracting picture with respect to the dimension of the picture 42. When the dimension of the distracting picture is small, the control device 31 becomes able to enhance the probability of appropriately extracting the picture 42 from the high-light-intensity partial image 41, and hence can prevent false recognition of the position of the photographic subject 29. In the object processing apparatus 1, as a result of appropriately calculating the position of the photographic subject 29, it becomes possible to appropriately hold the photographic subject 29 and hence to appropriately segregate the photographic subject 29.

In a low-light-intensity partial image 51 that is clipped from a low-light-intensity image taken when a plurality of pieces of recyclable waste is illuminated by the visible light having a low light intensity, for example, a picture 52 of the photographic subject 29 appears as illustrated in FIG. 6. FIG. 6 is a diagram illustrating the low-light-intensity partial image 51. The low-light-intensity partial image 51 is clipped from a low-light-intensity image based on the first-type elapsed time and the second-type elapsed time representing the difference in the image capturing timings, so that the position of appearance of the picture 52 in the low-light-intensity partial image 51 is identical to the position of appearance of the picture 42 in the high-light-intensity partial image 41. When the position of the picture 52 is identical to the position of the picture 42, the control device 31 can use the same calculation method as calculating the position of the photographic subject 29 based on the high-light-intensity partial image 41, and can easily calculate the position of the photographic subject 29 based on the low-light-intensity partial image 51.

The picture 52 does not include any overexposed region in which overexposure has occurred. That is, the light intensity of the visible light having a low light intensity is set to be smaller than the light intensity of the visible light having a high light intensity.

When a plurality of objects appears in the high-light-intensity partial image 41, if each picture capturing one of the objects includes an overexposed region, then sometimes the boundaries among those pictures disappear in the high-light-intensity partial image 41. Hence, there are times when a plurality of pictures appearing in the high-light-intensity partial image 41 cannot be appropriately differentiated, and the position of the center of gravity of the photographic subject 29 included among a plurality of objects cannot be appropriately calculated using only the high-light-intensity partial image 41. In the object processing apparatus 1, when the position of the center of gravity of the photographic subject 29 cannot be appropriately calculated, the photographic subject 29 neither can be appropriately held nor can be appropriately segregated.

Since an overexposed region is not included in the low-light-intensity image that is taken when a plurality of pieces of recyclable waste is illuminated by the visible light having a low light intensity, it becomes possible to appropriately differentiate among a plurality of pictures each of which captures one of a plurality of objects in the low-light-intensity image. Hence, even when a plurality of objects appears in the low-light-intensity partial image 51, the control device 31 can appropriately extract the picture 52 of the photographic subject 29 from the low-light-intensity partial image 51. As a result of appropriately extracting the picture 52 of the photographic subject 29 from the low-light-intensity partial image 51, the control device 31 can prevent false recognition of the position of the photographic subject 29. In the object processing apparatus 1, as a result of appropriately calculating the position of the photographic subject 29, it becomes possible to appropriately hold the photographic subject 29 and hence to appropriately segregate the photographic subject 29.

When an ultraviolet light is projected onto a fluorescent material made of polyethylene terephthalate (PET), the fluorescent material emits fluorescence which is a visible light. When a plurality of pieces of recyclable waste is illuminated by an ultraviolet light, if the pieces of recyclable waste include any fluorescent material, a fluorescence image taken at that time is obtained using the fluorescence emitted from that fluorescent material. In a fluorescence partial image clipped from a fluorescence image, a picture of the photographic subject 29 is present in an identical manner to the case of the high-light-intensity partial image 41 and the low-light-intensity partial image 51. A fluorescence partial image is clipped from a fluorescence image in such a way that the position of the picture capturing the photographic subject 29 is identical to the position of the picture 42 as well as the position of the picture 52. That is, the control device 31 can perform image processing with respect to the fluorescence image based on the first-type elapsed time, and can appropriately clip a fluorescence partial image from the fluorescence image in such a way that the position of the picture capturing the photographic subject 29 is identical to the position of the picture 42.

In the high-light-intensity partial image 41 or the low-light-intensity partial image 51, there are times when a picture of an object made of glass and a picture of an object made of polyethylene terephthalate (PET) are present in an identical manner. Hence, there are times when the control device 31 is not able to differentiate a picture of an object made of glass from a picture of an object made of polyethylene terephthalate (PET) based on the high-light-intensity partial image 41 or the low-light-intensity partial image 51. In contrast, in a fluorescence image, pictures formed due to the fluorescence are included and, for example, the picture of an object made of polyethylene terephthalate (PET) appears in an appropriate manner.

For that reason, based on a fluorescence image taken when a plurality of pieces of recyclable waste is illuminated by an ultraviolet light, the control device 31 becomes able to easily differentiate the pictures of non-fluorescent objects from the pictures of fluorescent objects. As a result of differentiating between the pictures of non-fluorescent objects and the pictures of fluorescent objects, the control device 31 becomes able to determine whether or not the photographic subject 29 is made of polyethylene terephthalate (PET). As a result of determining whether or not the photographic subject 29 is made of polyethylene terephthalate (PET), the control device 31 becomes able to appropriately determine the material of the photographic subject 29. Hence, in the object processing apparatus 1, a picking robot from among a plurality of picking robots 15 associated to polyethylene terephthalate (PET) can be made to appropriately hold the object made of polyethylene terephthalate (PET), thereby enabling appropriate segregation of the photographic subject 29.

In this way, as a result of using the high-light-intensity partial image 41, the low-light-intensity partial image 51, and the fluorescence partial image; even when the photographic subject 29 is made of a variety of materials, the control device 31 becomes able to appropriately extract the picture capturing the photographic subject 29. As a result of appropriately extracting the picture of the photographic subject 29, the control device 31 becomes able to appropriately calculate the position of placement of the photographic subject 29 and to appropriately calculate the position of the center of gravity of the photographic subject 29. As a result of appropriately calculating the position of the center of gravity of the photographic subject 29, the control device 31 becomes able to appropriately hold the photographic subject 29 and to appropriately segregate it.

Herein, the object recognition device 10 calculates the position of an object based on three images that are taken when the object is illuminated under three illumination conditions. Alternatively, the object recognition device 10 can calculate the position of an object based on two images that are taken when the object is illuminated under two illumination conditions. Examples of such a pair of two images include: the pair of the high-light-intensity partial image 41 and the low-light-intensity partial image 51; the pair of the high-light-intensity partial image 41 and the fluorescence partial image; and the pair of the low-light-intensity partial image 51 and the fluorescence partial image. Even when the position of an object is calculated based on two images taken when the object is illuminated under two illumination conditions, the object recognition device 10 can appropriately extract the pictures in which the object appears and to appropriately calculate the position of the object.

Effects of Object Recognition Device 10 According to Embodiment

The object recognition device 10 according to the embodiment includes the illumination device 23, the camera 22, and the position calculating unit 36. The illumination device 23 illuminates the photographic subject 29. When the photographic subject 29 is illuminated by the illumination device 23 under a plurality of illumination conditions, the camera 22 takes a plurality of images in which the photographic subject 29 is captured. The position calculating unit 36 performs image processing with respect to the images, and calculates the position of placement of the photographic subject 29. In the object recognition device 10, as a result of using the camera 22 to take a plurality of images when the photographic subject 29 is illuminated under a plurality of illumination conditions, a plurality of images in which the photographic subject 29 appears in various forms can be taken without having to change the settings of the singular camera 22. In an image in which the photographic subject 29 is captured, according to the illumination condition at the time of image capturing, the picture of the photographic subject 29 may or may not appear in an appropriate manner. The object recognition device 10 according to the embodiment performs image processing with respect to an image, from among a plurality of images taken under a plurality of illumination conditions, in which the photographic subject 29 is appropriately captured, so that the picture in which the photographic subject 29 appears can be appropriately extracted from the image. As a result of appropriately extracting the picture of the photographic subject 29, the object recognition device 10 according to the embodiment becomes able to appropriately calculate the position of placement of the center of gravity of the photographic subject 29.

The object processing apparatus 1 according to the embodiment includes the object recognition device 10, the suction pad 16, the X-axis actuator 17, the Z-axis actuator 18, and the holding control unit 39. The X-axis actuator 17 and the Z-axis actuator 18 move the suction pad 16. The holding control unit 39 controls the X-axis actuator 17 and the Z-axis actuator 18 based on the position calculated by the position calculating unit 36, so that the suction pad 16 holds the photographic subject 29. In the object processing apparatus 1 according to the embodiment, since the object recognition device 10 appropriately calculates the position of the photographic subject 29, it becomes possible to appropriately hold the photographic subject 29, and to appropriately segregate a plurality of pieces of recyclable waste.

Meanwhile, in the object recognition device 10 according to the embodiment described above, the light sources 26 emit two types of visible lights having different light intensities. However, alternatively, the light sources 26 can emit two types of visible lights having different wavelengths. Examples of a plurality of types of visible lights include the red visible light, the green visible light, and the blue visible light. Thus, when a plurality of pieces of recyclable waste is illuminated by a plurality of types of visible lights, the control device 31 uses the camera 22 to take a plurality of images in which the pieces of recyclable waste are captured. In a red light image that is taken when the pieces of recyclable waste are illuminated by the red visible light, the red parts from among the pieces of recyclable waste are not appropriately captured, and the parts not having the red color from among the pieces of recyclable waste are appropriately captured. Similarly, in a green light image that is taken when the pieces of recyclable waste are illuminated by the green visible light, the green parts from among the pieces of recyclable waste are not appropriately captured, and the parts not having the green color from among the pieces of recyclable waste are appropriately captured. Moreover, in a blue light image that is taken when the pieces of recyclable waste are illuminated by the blue visible light, the blue parts from among the pieces of recyclable waste are not appropriately captured, and the parts not having the blue color from among the pieces of recyclable waste are appropriately captured. At that time, even when there are parts colored in red, green, and blue are present on the surface of a plurality of pieces of recyclable waste, the control device 31 can enhance the probability of appropriately extracting the pictures of the pieces of recyclable waste from a plurality of images.

The suction pad 16 described above may be replaced with a remover that removes the holding object from the carrier device 3 without holding the holding target. For example, the remover pushes the holding target out of the carrier device 3, flicks the holding target away from the carrier device 3, or blows air on the holding target to blow the holding target away from the carrier device 3.

The object recognition device and the object processing apparatus disclosed herein enable appropriate calculation of the position of an object from an image in which the object is captured.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the disclosure have been described in detail, it should be understood that the various changes, substitutions, and alterations could be made hereto without departing from the spirit and scope of the disclosure.

What is claimed is:

1. An object recognition device comprising:
an illuminator configured to illuminate an object;
an imager configured to
take a first-type image of the object when the object is illuminated by the illuminator under a first illumination condition, and
take a second-type image of the object when the object is illuminated by the illuminator under a second illumination condition different than the first illumination condition; and
circuitry configured to calculate a position of the object based on the first-type image and the second-type image.

2. The object recognition device according to claim 1, wherein the object is light transmittable.

3. The object recognition device according to claim 1, wherein, light intensity of a second-type light projected onto the object under the second illumination condition is greater than light intensity of a first-type light projected onto the object under the first illumination condition such that a portion of overexposure occurring in the second-type image is larger than a portion of overexposure occurring in the first-type image.

4. The object recognition device according to claim 1, wherein wavelength of a first-type light projected onto the object under the first illumination condition is different than wavelength of a second-type light projected onto the object under the second illumination condition.

5. The object recognition device according to claim 4, wherein
the first-type image is taken based on light reflecting from the object after projection of the first-type light onto the object, and
the second-type image is taken based on fluorescent light emitted from the object after projection of the second-type light onto the object.

6. The object recognition device according to claim 1, wherein
when the object is illuminated by the illuminator under a third illumination condition that is different than the first illumination condition and the second illumination condition, the imager takes a third-type image of the object, and
the circuitry calculates the position based on the first-type image, the second-type image, and the third-type image.

7. The object recognition device according to claim 1, further comprising a conveyor, wherein
the object is carried by the conveyor such that a first position of the object at a first timing of taking the first-type image is different than a second position of the object at a second timing of taking the second-type image, and
the circuitry
clips a first-type image portion from the first-type image,
clips a second-type image portion from the second-type image such that position in which the object is appeared in the first-type image portion is identical to position in which the object is appeared in the second-type image portion, and
calculates the position based on the first-type image portion and the second-type image portion.

8. The object recognition device according to claim 1, wherein the circuitry determines material of the object based on the first-type image and the second-type image.

9. An object processing apparatus comprising:
a remover configured to remove an object;
a driver configured to move the remover;
an illuminator configured to illuminate the object;
an imager configured to
take a first-type image of the object when the object is illuminated by the illuminator under a first illumination condition, and
take a second-type image of the object when the object is illuminated by the illuminator under a second illumination condition different than the first illumination condition; and
circuitry configured to
calculate a position of the object based on the first-type image and the second-type image, and
control the driver based on the position such that the remover removes the object.

10. The object processing apparatus according to claim 9, further comprising a conveyor configured to carry the object, wherein
when the object is carried by the conveyor, the circuitry controls the driver such that the remover removes the object from the conveyor at a timing that is calculated based on a timing at which the first-type image was taken.
